(19) United States
(12) Patent Application Publication
(10) Pub. No.: US 2026/0011952 A1
(43) Pub. Date: Jan. 8, 2026

(54) ELECTRICAL CONNECTOR

(71) Applicant: Xiaoping Zhu, Dongguan (CN)

(72) Inventor: Xiaoping Zhu, Dongguan (CN)

(21) Appl. No.: 19/324,111

(22) Filed: Sep. 10, 2025

(30) Foreign Application Priority Data
Sep. 1, 2025 (CN) 202511240862.6

(51) Int. Cl. H01R 13/621; H01R 13/627; H01R 24/30; H01R 43/26; H01R 105/00

(52) U.S. Cl. CPC H01R 13/6215; H01R 13/6275; H01R 24/30; H01R 43/26; H01R 2105/00

(57) ABSTRACT

An electrical connector is provided, including a shell, an electrical connection portion, and a shaft lever. The electrical connection portion is arranged on the shell. The shaft lever is provided with a first threaded region and a second threaded region. The first threaded region has the same thread direction as the second threaded region, and is in threaded connection with the shell. The second threaded region is configured to be screwed into a hole of the adapter connector to be fastened with an inner wall of the adapter connector. The electrical connector can be fastened to the adapter connector in a more stable locking manner.

### TECHNICAL FIELD

The present disclosure relates to the technical field of connectors, and in particular, to an electrical connector capable of being stably locked to an adapter connector.

### BACKGROUND

Electrical connectors can implement electrical connection and are commonly applied to electrical equipment. In order to prevent disengagement after an electrical connector is electrically connected to an adapter connector, a locking structure will be arranged on the electrical connector. The existing locking structure is usually a fastener. The fastener is fastened to the adapter connector to implement stable connection between the electrical connector and the adapter connector. This locking structure is relatively easily released due to a weak locking force.

### SUMMARY

In view of this, in order to solve one of the technical problems in the related art to an extent, it is necessary to provide an electrical connector which can be fastened to an adapter connector in a more stable locking manner.

The electrical connector includes a shell, an electrical connection portion, and a shaft lever. The electrical connection portion is arranged on the shell. The shaft lever is provided with a first threaded region and a second threaded region. The first threaded region has the same thread direction as the second threaded region, and is in threaded connection with the shell. The second threaded region is configured to be screwed into a hole of the adapter connector to be fastened with an inner wall of the adapter connector.

### BRIEF DESCRIPTION OF THE DRAWINGS

FIG. 1 is a schematic structural diagram of a first specific implementation of the present disclosure in a fastened state.

FIG. 2 is a schematic internally structural diagram of a first specific implementation of the present disclosure in a fastened state.

FIG. 3 is a left view of a first specific implementation of the present disclosure after a second threaded region is screwed into a hole of an adapter connector.

FIG. 4 is a front view of a first specific implementation of the present disclosure after a second threaded region is screwed into a hole of an adapter connector.

FIG. 5 is a schematic structural diagram of a first specific implementation of the present disclosure in a released state.

FIG. 6 is an enlarged view of part I in FIG. 5.

FIG. 7 is a schematic structural diagram of a second specific implementation of the present disclosure in a released state.

FIG. 8 is a schematic internally structural diagram of a second specific implementation of the present disclosure in a released state.

FIG. 9 is a schematic internally structural diagram of a second specific implementation of the present disclosure in a fastened state.

FIG. 10 is a first embodiment of a shaft lever of a second specific implementation of the present disclosure.

FIG. 11 is a second embodiment of a shaft lever of a second specific implementation of the present disclosure.

FIG. 12 is a third embodiment of a shaft lever of a second specific implementation of the present disclosure.

FIG. 13 is a schematic structural diagram of cooperation between a second pin and a locking portion of a second specific implementation of the present disclosure.

The present disclosure will be further described below according to specific implementations with reference to the above accompanying drawings.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the embodiments of the present disclosure without making creative efforts shall fall within the protection scope of the present disclosure. It can be understood that the accompanying drawings are only for reference and illustration purposes and are not intended to limit the present disclosure. The connection relationship shown in the accompanying drawings is only for the sake of clear description and does not limit a connection method.

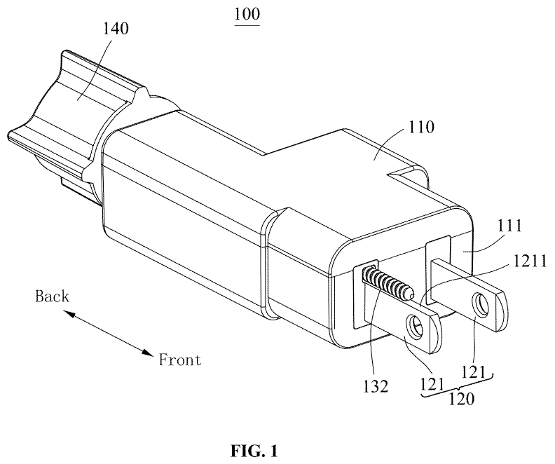

A first specific implementation of the present disclosure provides an electrical connector 100. As shown in FIG. 1, the electrical connector 100 includes a shell 110 and an electrical connection portion 120 arranged on the shell 110. The electrical connection portion 120 is connected with a wire inside the shell 110. In this specific implementation, the electrical connector 100 is a plug. The electrical connection portion 120 includes two first pins 121. The first pins 121 protrude out of a front wall 111 of the shell 110. Further, one first pin 121 may be a neutral wire pin, and the other first pin 121 may be a live wire pin.

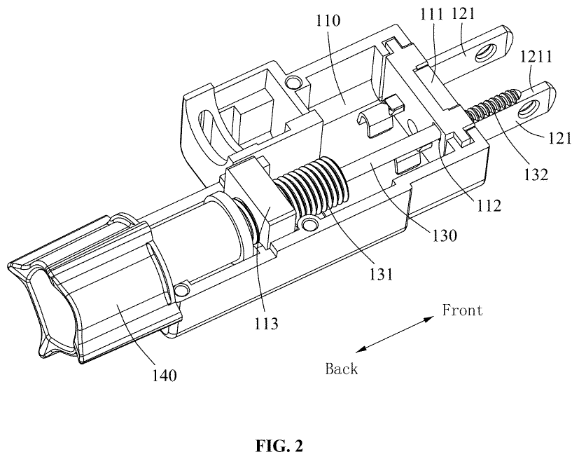

Continuing to refer to FIG. 2, the electrical connector 100 further includes a shaft lever 130. The shaft lever 130 is provided with a first threaded region 131 and a second threaded region 132. A thread screwing direction of the first threaded region 131 is the same as a thread screwing direction of the second threaded region 132. The second threaded region 132 is arranged at a front section of the shaft lever 130. The first threaded region 131 is in threaded connection with the shell 110, and a nut 113 can be arranged inside the shell 110. The first threaded region 131 is in threaded fit with the nut 113. A tail portion of the shaft lever 130 is connected to a knob handle 140. The knob handle 140 is located on a rear side of the shell 110. When a user spins the knob handle 140, the shaft lever 130 can move forward or backward relative to the shell 110 while rotating, thereby causing the second threaded region 132 to move forward or backward relative to the shell 110 while rotating.

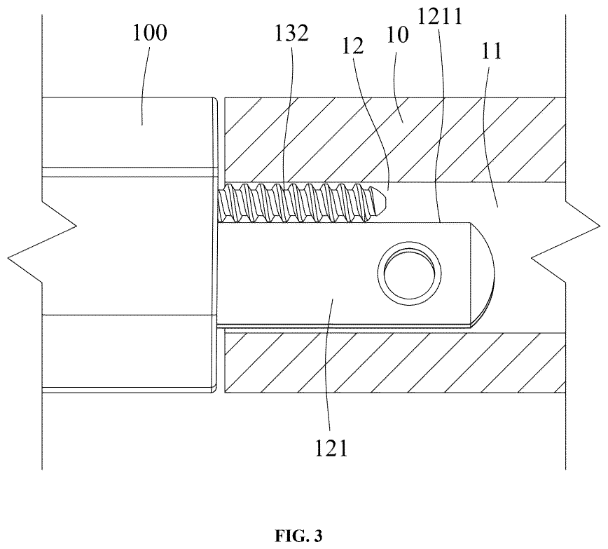

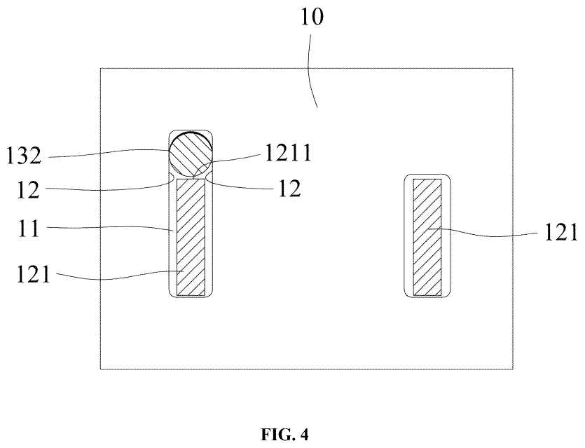

A via hole 112 is formed in the front wall 111 of the electrical connector 100. When the shaft lever 130 rotates clockwise, an end portion of the shaft lever 130 can move forward and extend from the via hole 112 to a front side of the front wall 111. The second threaded region 132 also rotates clockwise and moves forward relative to the shell 110. As shown in FIG. 3 and FIG. 4, in the forward movement process, the second threaded region 132 can be screwed into a hole 11 of an adapter connector 10 in the thread screwing direction. During screwing in, the second threaded region 132 can make the electrical connector 100 and the adapter connector 10 tend to approach each other. The second threaded region 132 can tightly grasp an inner wall 12 of the adapter connector 10 and be fastened, so that it is difficult to easily loosen the electrical connector 100 from the adapter connector 10.

The second threaded region 132 is preferably a self-tapping cutting thread. In the process of being screwed into the hole 11, the self-tapping cutting thread can be gradually tightened on the inner wall 12 of the adapter connector 10 in a cutting and squeezing manner.

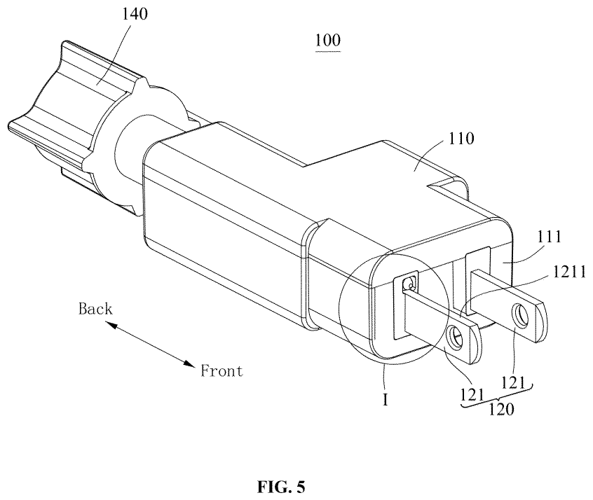

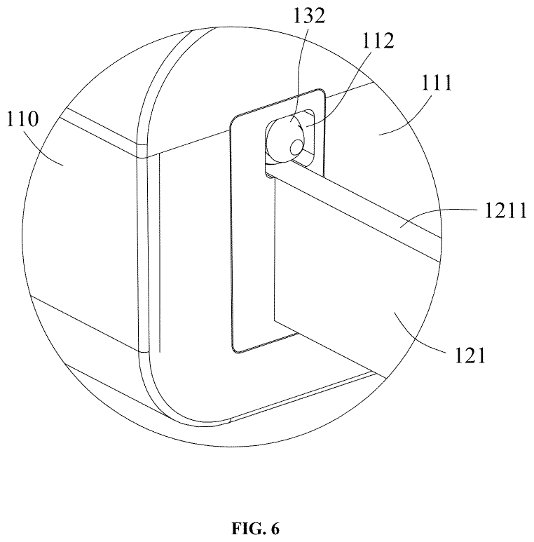

As shown in FIG. 5 and FIG. 6, when the shaft lever 130 rotates counterclockwise, the end portion of the shaft lever 130 can retract into the shell 110. The second threaded region 132 rotates counterclockwise and moves backward relative to the shell 110. During screwing out,
the second threaded region 132 can be screwed out of the hole of the adapter connector 10 in the thread screwing direction. The second threaded region 132 can make the electrical connector 100 and the adapter connector 10 tend to move away from each other. The second threaded region 132 will be released from threaded locking to the inner wall 12 of the adapter connector 10, and a user can separate the electrical connector 100 from the adapter connector 10.

In this specific implementation, referring to FIG. 3 and FIG. 4, the adapter connector 10 is a socket that adapts to the first pin 121. The hole 11 of the adapter connector 10 is a plugging hole for plugging the first pin 121 serving as the neutral or live wire pin. After the first pin 121 is plugged into the hole 11, the first pin 121 is electrically connected to a conductive plate inside the adapter connector 10.

The hole 11 can simultaneously accommodate the first pin 121 and the second threaded region 132. The first pin 121 and the second threaded region 132 can enter the hole 11 of the adapter connector 10 together, thus fastening the second threaded region 132 to two opposite inner walls 12 of the adapter connector 10 while implementing electrical connection between the first pin 121 and the adapter connector 10. Therefore, the electrical connector 100 can be applied to a general-purpose adapter connector 10. Certainly, the hole 11 can also be a hole that is additionally formed in the adapter connector 10 and is not used for plugging a pin.

An axis of the shaft lever 130 can be selected to be parallel to an extension direction of the first pin 121.

When the second threaded region 132 is in a fastened state, the second threaded region 132 is located on one side of the first pin 121. Specifically, when the second threaded region 132 is in the fastened state, the second threaded region 132 is located on a thin surface 1211 of the first pin 121 and can be clung to the thin surface 1211. A diameter of the second threaded region 132 can be equivalent to or slightly greater than a width of the first pin 121, so that the second threaded region 132 is fastened to the two opposite inner walls 12 of the hole 11. A maximum diameter of the second threaded region 132 is preferably within a size range of 2.2 to 2.6 mm.

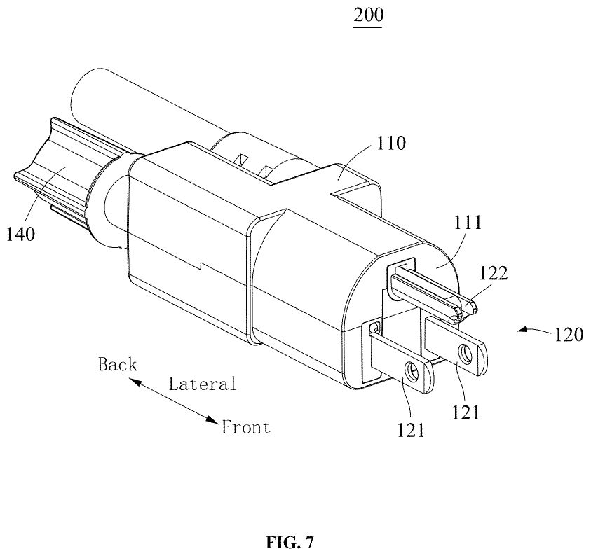

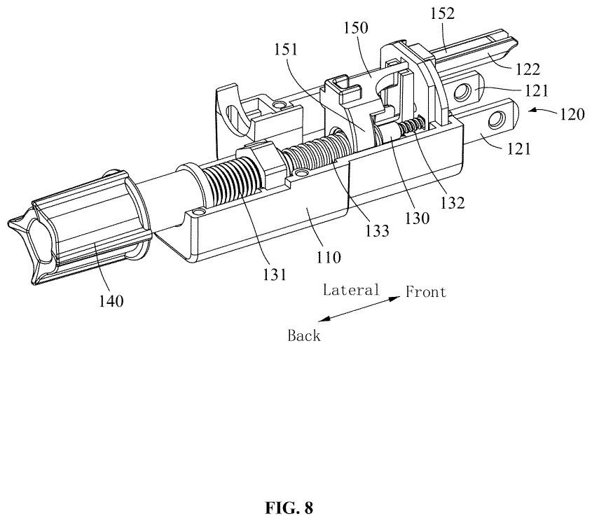

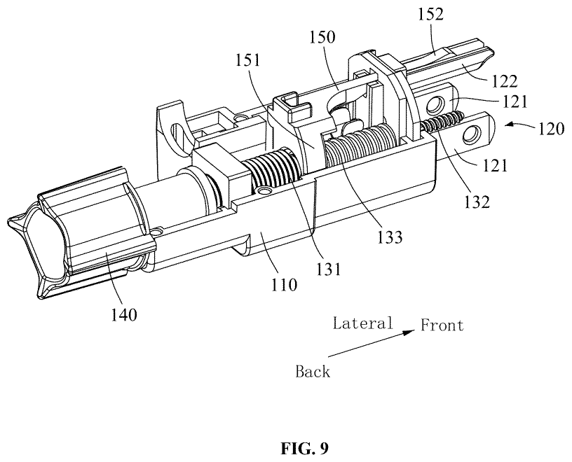

A second specific implementation of the present invention provides an electrical connector 200. As shown in FIG. 7 to FIG. 9, in addition to the structures of the first specific implementation, the electrical connector 200 further includes a locking member 150 and a guide rail 133. The guide rail 133 is arranged in a circumferential direction of the shaft lever 130 and may be a threaded guide rail or an annular guide rail.

The guide rail 133 is located between the first threaded region 131 and the second threaded region 132. The guide rail 133 can move forward or backward relative to the shell 110 as the shaft lever 130 rotates.

The locking member 150 is configured to be locked with another portion of the adapter connector 10. For example, it can be plugged into a gap between the electrical connector 200 and the adapter connector 10 (including between shells), and the electrical connector 200 and the adapter connector 10 are locked by rubbing locking. The locking member 150 and the second threaded region 132 are locked in a plurality of portions, which can improve the locking force between the electrical connector 200 and the adapter connector 10, and prevent a problem that releasing easily occurs during shaking because of locking in a single portion.

The locking member 150 includes a connection portion 151 and a locking portion 152. The locking portion 152 may be a tab structure. The connection portion 151 is connected to the guide rail 133. When the shaft lever 130 rotates and moves forward or backward, the connection portion 151 is driven by the shaft lever 130 to move laterally forward or backward relative to the shell 110, thereby causing the locking member 150 to be in a locking position or a releasing position.

A movement direction of the locking member 150 can be restricted by a linear guide rail (such as a guide rail strip or a guide rail slot) on the shell 110 to be front-back lateral movement. When the shaft lever 130 rotates and moves front and back, the locking member 150 can be pushed to move front and back by the guide rail 133.

When the shaft lever 130 is screwed in and moves forward, the locking member 150 moves to the locking position relative to the shell 110. The locking portion 152 and the second threaded region 132 are locked together with the adapter connector 10. When the shaft lever 130 is screwed out and moves backward, the locking member 150 moves to the locking position relative to the shell 110. The locking portion 152 and the second threaded region 132 are released together from the adapter connector 10.

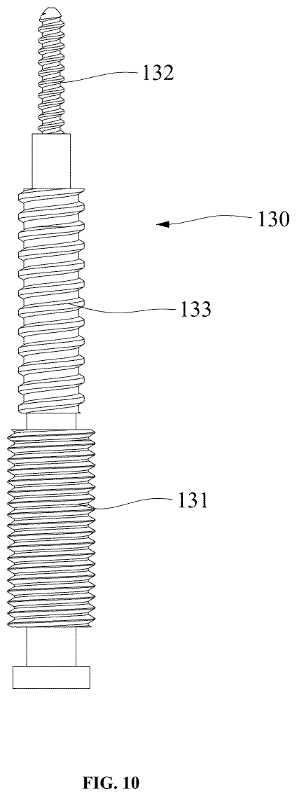

In a first embodiment, as shown in FIG. 10, the guide rail 133 is a threaded guide rail, which is a third threaded region 133 arranged on the shaft lever 130. A thread screwing direction of the third threaded region 133 is the same as the thread screwing direction of the first threaded region 131, and a thread lead of the third threaded region 133 is greater than a thread lead of the first threaded region 131. In this case, when the shaft lever 130 is screwed in, under the guidance of the third threaded region 133, the locking member 150 moves backward to the locking position. When the shaft lever 130 is screwed out, the locking member 150 moves forward to the releasing position. The shaft lever 130 rotates a circle, and a movement distance of the locking member 150 is equal to the lead of the third threaded region 133 minus the lead of the first threaded region 131.

The thread lead of the third threaded region 133 is preferably 1 to 2 times the thread lead of the first threaded region 131.

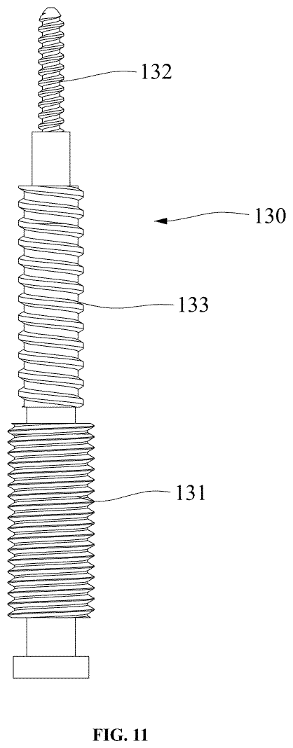

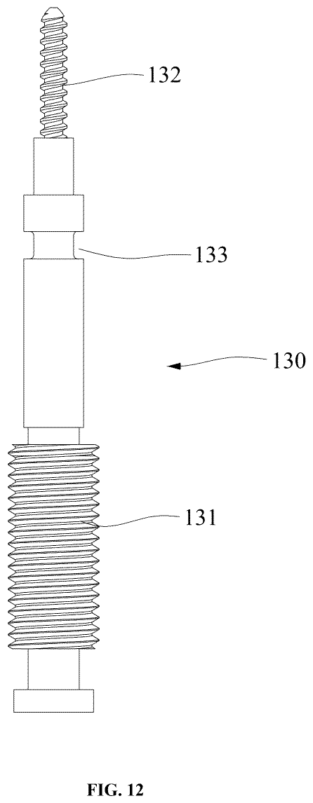

In a second embodiment, as shown in FIG. 11, the guide rail 133 is a threaded guide rail, which is a third threaded region 133 arranged on the shaft lever 130. However, a difference is that a thread screwing direction of the third threaded region 133 is opposite to the thread screwing direction of the first threaded region 131. In a third embodiment, as shown in FIG. 12, the guide rail 133 is an annular guide rail 133, such as an annular closed slot (non-spiral). In the second embodiment and the third embodiment, when the shaft lever 130 is screwed in, the locking member 150 moves forward to the locking position, and when the shaft lever 130 is screwed out, the locking member 150 moves backward to the releasing position.

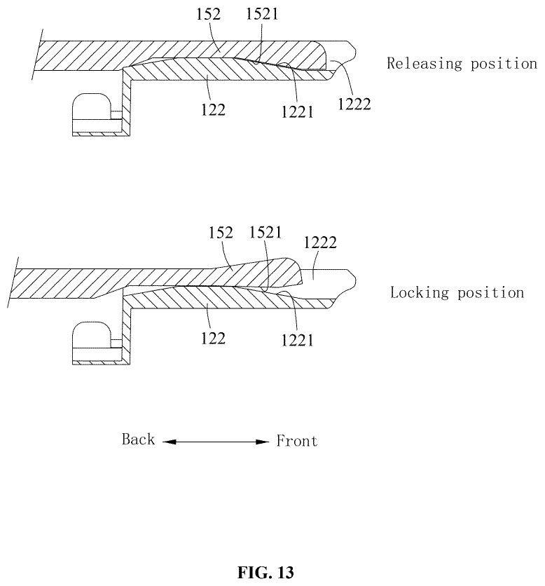

As shown in FIG. 7 to FIG. 9 and FIG. 13, the locking member 150 can cooperate with the second pin 122 of the electrical connection portion 120 to implement locking or releasing, and the second pin 122 is a ground pin. The second pin 122 is provided with a first guiding inclined surface 1221. A locking portion 152 of the locking member 150 is provided with a second guiding inclined surface 1521 that matches the first guiding inclined surface 1221. When the locking portion 152 is in the locking position, the first guiding inclined surface 1221 acts on the second guiding inclined surface 1521, causing the locking portion 152 to at least partially protrude out of the second pin 122.

Preferably, the locking member 150 moves backward to place the locking portion 152 in the locking position. In this case, in the gradual backward movement process of the locking member 150, with the cooperation between the second guiding inclined surface 1521 and the first guiding inclined surface 1221, the locking portion 152 can be subjected to a diagonal backward pulling force, and the adapter connector 10 can provide the locking portion 152 with an opposite (diagonal forward) force, causing the locking member 150 to tend to move towards the adapter connector 10. Therefore, during locking, it can be avoided that the second pin 122 tends to leave the adapter connector 10 and cut off the electrical connection.

The second pin 122 is provided with an accommodating slot 1222. The first guiding inclined surface 1221 is arranged in the accommodating slot 1222. When the locking member 150 is in the releasing position, the locking portion 152 is accommodated in the accommodating slot 1222. In this case, the locking portion 152 can be plugged into a corresponding plugging hole of the adapter connector 10 together with the second pin 122. After the insertion, the knob handle 140 is spun, and the locking member 150 moves. When the locking portion 152 is in the locking position, the locking portion 152 at least partially protrudes out of the accommodating slot 1222, preferably protrudes out of the second pin 122 by 1.2 mm or more. In this case, a protruding portion of the locking portion 152 can be locked to an inner wall of the adapter connector 10 in a rubbing and squeezing manner.

The above only describes the preferred embodiments of the present disclosure and is not intended to limit the present disclosure. Any modification, equivalent replacement, and improvement made within the spirit and principle of the present disclosure shall fall within the protection scope of the present disclosure.

What is claimed is:

1. An electrical connector, wherein the electrical connector comprises:
a shell;
an electrical connection portion, wherein the electrical connection portion is arranged on the shell; and
a shaft lever, wherein the shaft lever is provided with a first threaded region and a second threaded region; a thread screwing direction of the first threaded region is the same as a thread screwing direction of the second threaded region, and is in threaded connection with the shell; and the second threaded region is configured to be screwed into a hole of the adapter connector to be fastened with an inner wall of the adapter connector.

2. The electrical connector according to claim 1, wherein the electrical connector is a plug; the adapter connector is a socket; the electrical connection portion comprises a first pin; and the first pin and the second threaded region enter the hole of the adapter connector together to electrically connect the first pin with the adapter connector.

3. The electrical connector according to claim 2, wherein when the second threaded region is in a fastened state, the second threaded region is located on a thin surface of the first pin.

4. The electrical connector according to claim 1, wherein the second threaded region is a self-tapping cutting thread.

5. The electrical connector according to claim 1, wherein the electrical connector further comprises:
a guide rail arranged in a circumferential direction of the shaft lever; and
a locking member, wherein the locking member is configured to be locked to another portion of the adapter connector; the locking member is connected to the guide rail; when the shaft lever is screwed in, the locking member is driven by the shaft lever to move laterally relative to the shell and be in a locking position; and when the shaft lever is screwed out, the locking member is driven by the shaft lever to move laterally relative to the shell and be in a releasing position.

6. The electrical connector according to claim 5, wherein the guide rail is a third threaded region arranged on the shaft lever; a thread screwing direction of the thread threaded region is the same as the thread screwing direction of the first threaded region; and a thread lead of the third threaded region is greater than a thread lead of the first threaded region.

7. The electrical connector according to claim 6, wherein the thread lead of the third threaded region is 1 to 2 times the thread lead of the first threaded region.

8. The electrical connector according to claim 5, wherein the guide rail is a third threaded region arranged on the shaft lever; a thread screwing direction of the thread threaded region is opposite to the thread screwing direction of the first threaded region; or, the guide rail is an annular rail.

9. The electrical connector according to claim 5, wherein the electrical connection portion comprises a second pin; the second pin is provided with a first guiding inclined surface; a locking portion of the locking member is provided with a second guiding inclined surface that matches the first guiding inclined surface; and when the locking portion is in the locking position, the first guiding inclined surface acts on the second guiding inclined surface, causing the locking portion to at least partially protrude out of the second pin.

10. The electrical connector according to claim 9, wherein an accommodating slot is formed in the second pin; the first guiding inclined surface is arranged in the accommodating slot; the locking portion is accommodated in the accommodating slot when the locking member is in the releasing position; and the locking portion at least partially protrudes out of the accommodating slot when the locking portion is in the locking position.
